(19) United States
(12) Patent Application Publication
(10) Pub. No.: US 2011/0204737 A1
(43) Pub. Date: Aug. 25, 2011

(54) Polar cross permanent magnet motor

(76) Inventor: Daniel E. South, Palmer, AK (US)

(21) Appl. No.: 12/660,271

(22) Filed: Feb. 24, 2010

(51) Int. Cl. H02K 21/00; H02N 11/00

(52) U.S. Cl. 310/152; 415/916

(57) ABSTRACT

With the discovery of the Polar Cross Method claimed herein a valuable new method of the geometrical arrangement, linkage and/or constraint of component magnets in a permanent magnet powered device is invented. Additionally the Polar Cross Process claimed herein defines the transformation of electromagnetic energy exhibited by the fields of the component magnets into kinetic energy utilizing the Polar Cross Method to achieve the transformation. The Polar Cross Process is applied to achieve the design of the Polar Cross Permanent Magnet Motor device, also claimed herein. The invention includes a method, process and apparatus for utilizing the energy exhibited by fields of permanent magnets to produce motive force in a device such as a permanent magnet motor without the requirement for a continuously supplied external electrical power source or other fuel source supply to operate.

### CROSS-REFERENCE TO RELATED APPLICATIONS

This patent application claims priority from provisional patent application No. 61/211,155 having a filing date of Mar. 25, 2009.

### FIELD OF THE INVENTION

The invention pertains to the field of permanent magnet motor devices which utilize the magnetic fields of the component magnets to produce motive power.

### BACKGROUND OF THE INVENTION

An electrical conductor moving through a magnetic field induces an electrical current in the conductor, and an electrical current in a conductor creates a magnetic field in proximity to the conductor.

Electric motors operate on the principle that when a current carrying conductor is located in a magnetic field a magnetic force is exerted upon it. The rotor or the stator—or both, are constructed and wired such that magnetic fields present in either or created according to above referenced electromagnetic principles are utilized in the operation of the motor to cause the rotational or linear displacement of the rotor versus the stator. The electrical power supplied is converted to magnetic fields which then are utilized to produce mechanical motive power.

Conventional electric motors are constructed thus to utilize the resultant forces between said magnetic fields to produce motive power from supplied electrical power. They also require switching means to energize the electromagnets with the correct polarity at the proper moment in their typical rotational cycle.

Electric generation devices operate on the reverse of the motor principle, wherein mechanical energy input is converted to electrical energy output. Some devices can operate as both an electric motor or an electric generator depending on which energy input is provided.

Permanent magnets are commonly known to exhibit polarized magnetic fields for a long period of time without the requirement for continuous external energy supply. Also commonly known is the north pole of one magnet is attracted to the south pole of another and the same thing is true in reverse—and like poles are repelled by each other.

Magnetic field interactions are employed to achieve these processes to transform mechanical energy to electrical energy, and electrical energy to mechanical energy.

Prior art in this field has experienced limited success, to my knowledge only U.S. Pat. Nos. 4,151,431 and 4,215,330 have been granted for a device with the primary object of the invention to utilize existing magnet's fields to provide the motive force to operate a motor.

Past attempts at permanent magnet motor inventions were plagued with attempts to utilize the fields exhibited by permanent magnets by means that introduced issues including those of transitioning between steps of operation of the device somewhat analogous to the requirement for switching mechanisms in conventional motors, also known as problems with latching and resetting.

### BRIEF SUMMARY OF THE INVENTION

It is an object of the invention to utilize the existing magnetic fields of permanent magnets to produce motive force as to cause a motor to be powered by the magnetic fields exhibited by permanent magnets. In the practice of the inventive concepts, motors of many embodiments of the invention may be produced, but each device must necessarily conform to the dictates of the following inventive concepts.

The Polar Cross Method is the geometrical arrangement, linkage and/or constraint of two or more magnetized components such that the relative direction of movement between the poles of said magnets and the relative polarity relationship of or between the poles of said magnets reverses concurrently, wherein the arrangement of the magnets is with regard to their North and South poles.

The Polar Cross Process defines the transformation of electromagnetic energy exhibited by the fields of the component magnets into kinetic energy in a system of components utilizing the Polar Cross Method.

The correct application of the invented concepts underlying the operation of numerous possible magnet motor and related device designs fundamentally addresses both the resetting and latching issues, and thereby enables the construction of such a useful motor as the Polar Cross Permanent Magnet Motor which does not require a continuously supplied external power source or consume fuel to operate.

### BRIEF DESCRIPTION OF THE SEVERAL VIEWS OF THE DRAWING

The patent or application file contains at least one drawing executed in color. Copies of this patent or patent application publication with color drawing(s) will be provided by the Office upon request and payment of the necessary fee.

FIG. 1: Front page view:
Top side section view at plane of center line of turbine bi-level opening;

FIG. 2: Bottom side plan view of motor outer case assembly;

FIG. 3: Top side plan view with top cover removed—outlines only;

FIG. 4: Left side elevation of motor outer case assembly;

FIG. 5: Left side elevation of motor turbine component;

FIG. 6: Cross section view of main shafts and turbine assemblies;

FIG. 7: Cylinder core inner side perimeter view segment:
Segment of cylinder core viewed from inside perimeter;
Seven of a total of sixteen cylinder areas are shown;

FIG. 8: Inner and outer core interface sides view segment:
Segment of interface between inner and outer core features;
Five of a total of sixteen idealized junction areas are shown;

FIG. 9: Elevation of outer case side view segment:
Segment of perimeter of outer case side features;
Five of a total of 16 segments of outer case perimeter shown;

FIG. 10: Section view of turbine vane and incline step patterns:

FIG. 11: Front side view of fundamental concept device example.

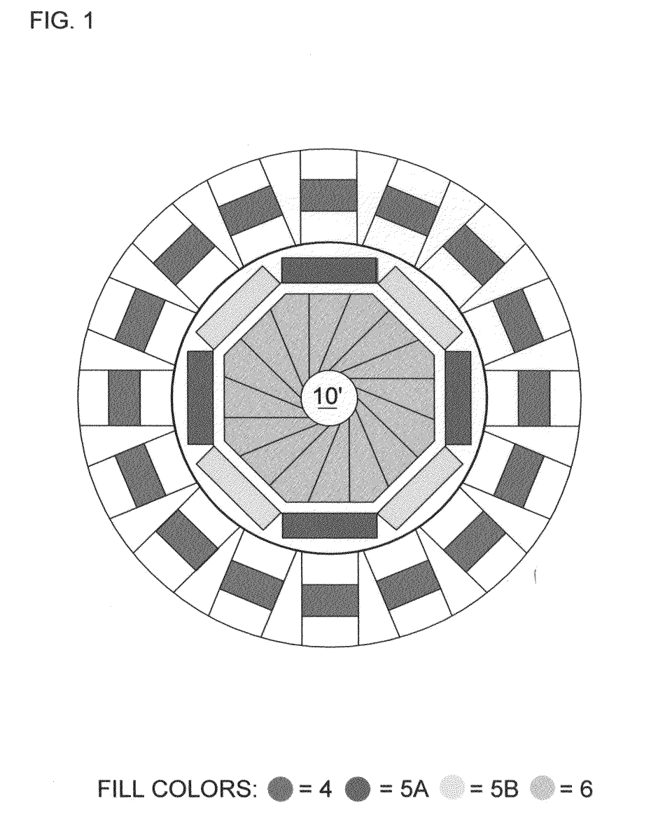

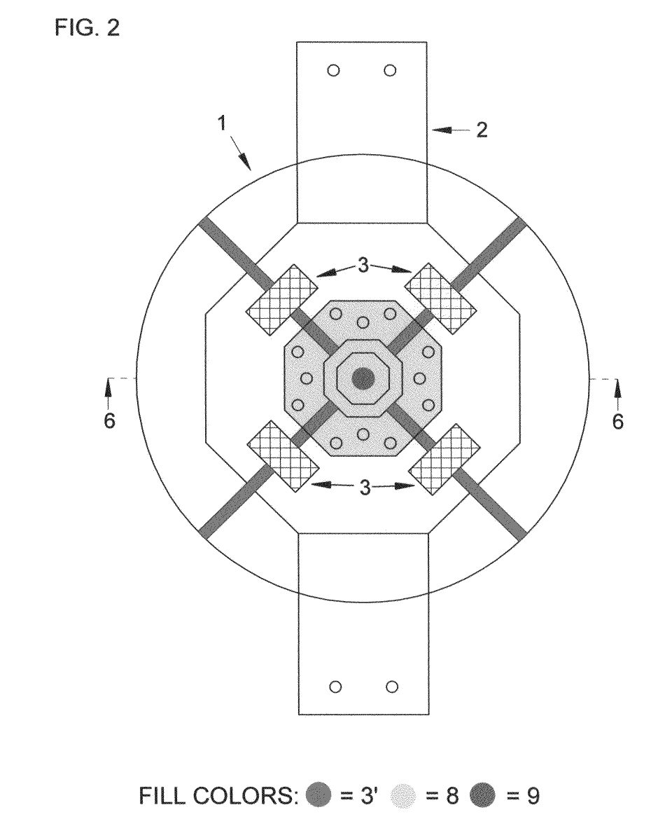

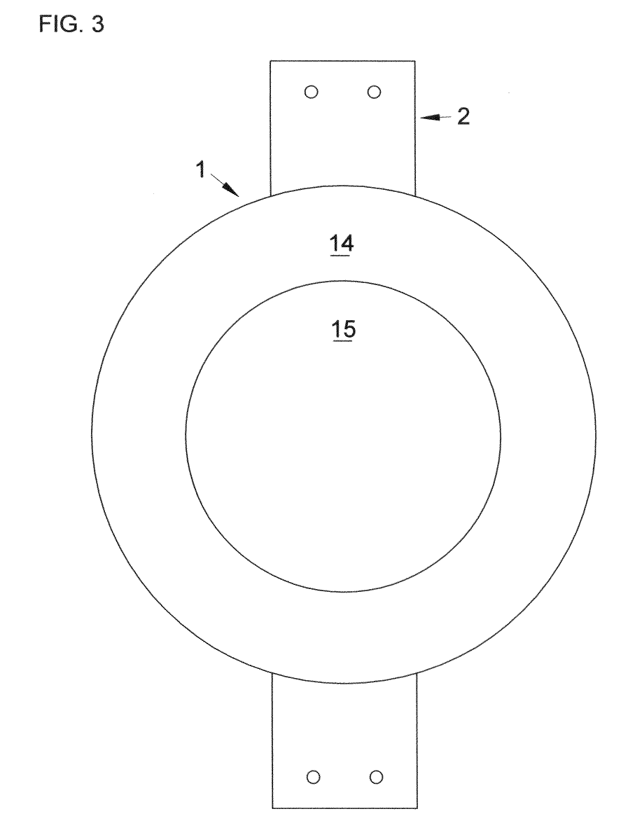

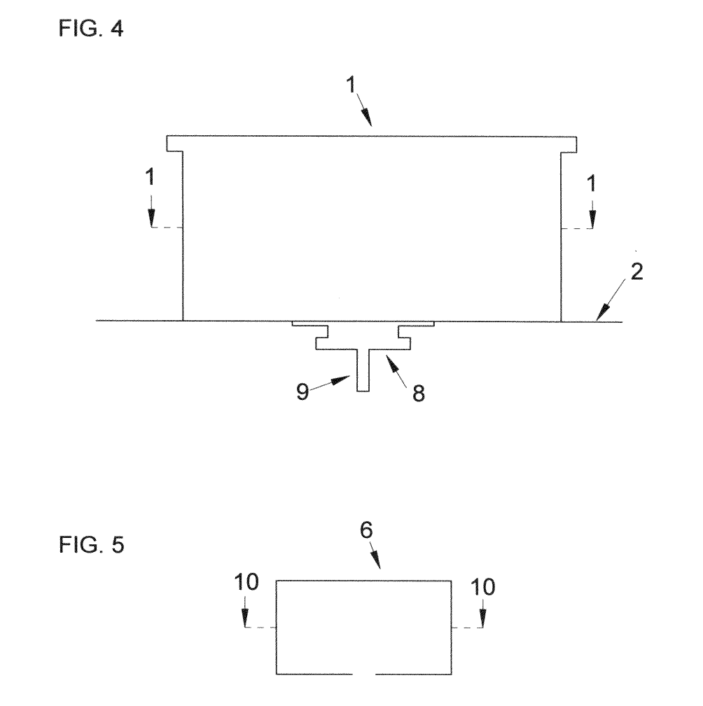

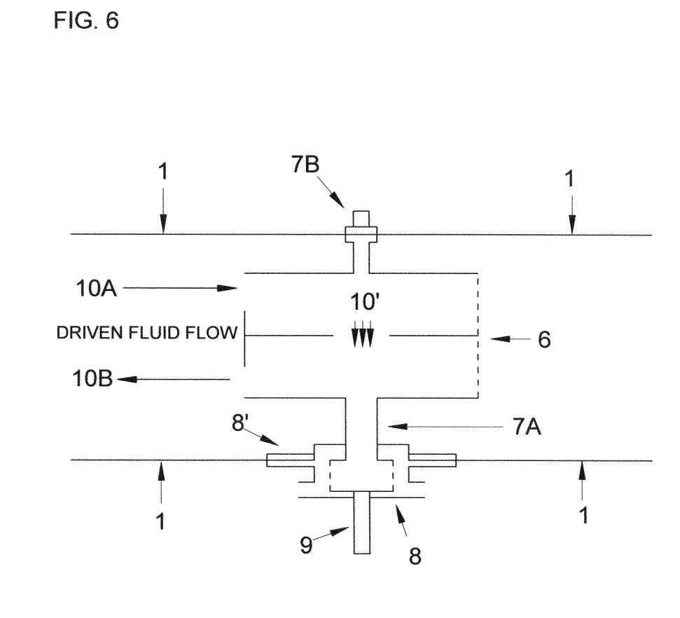

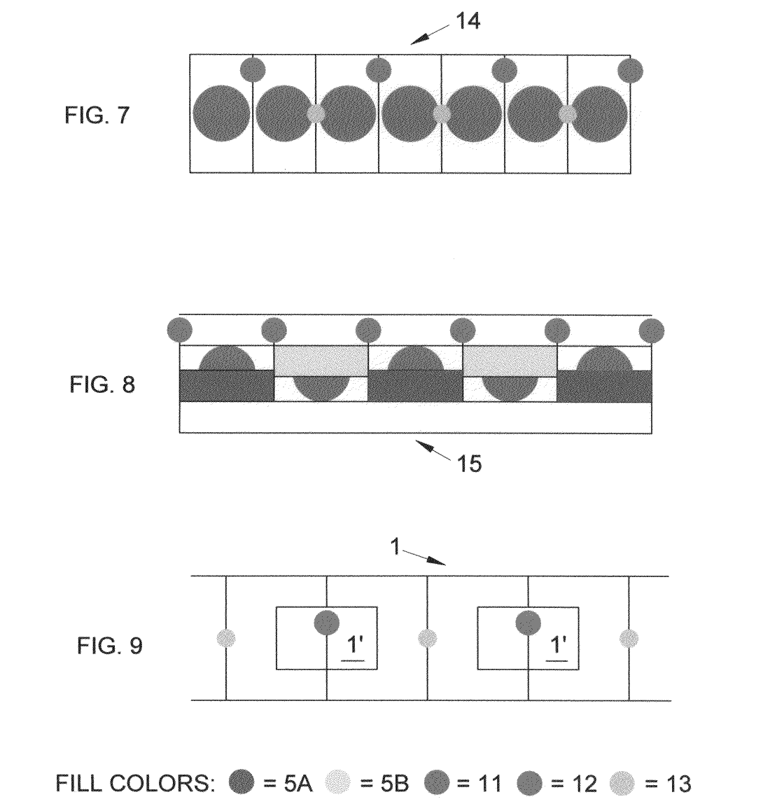

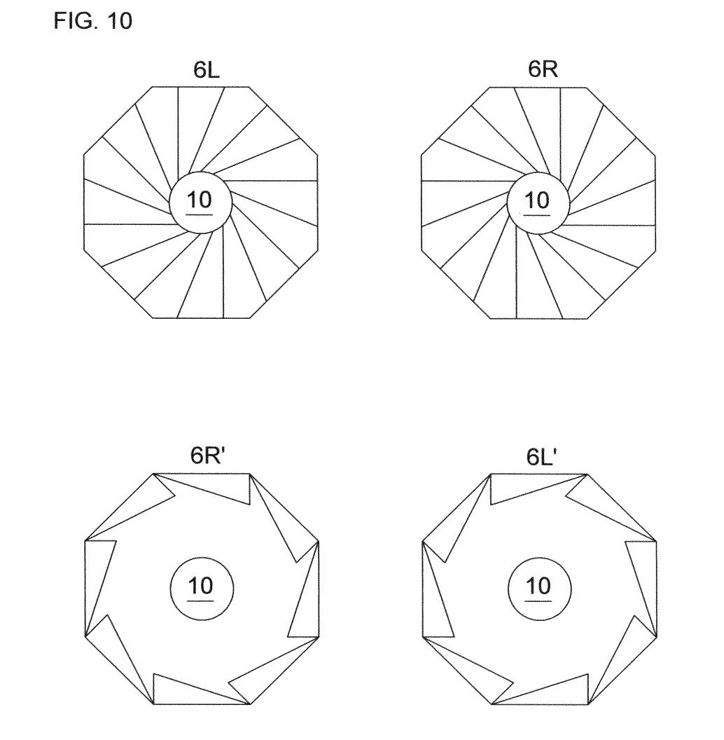

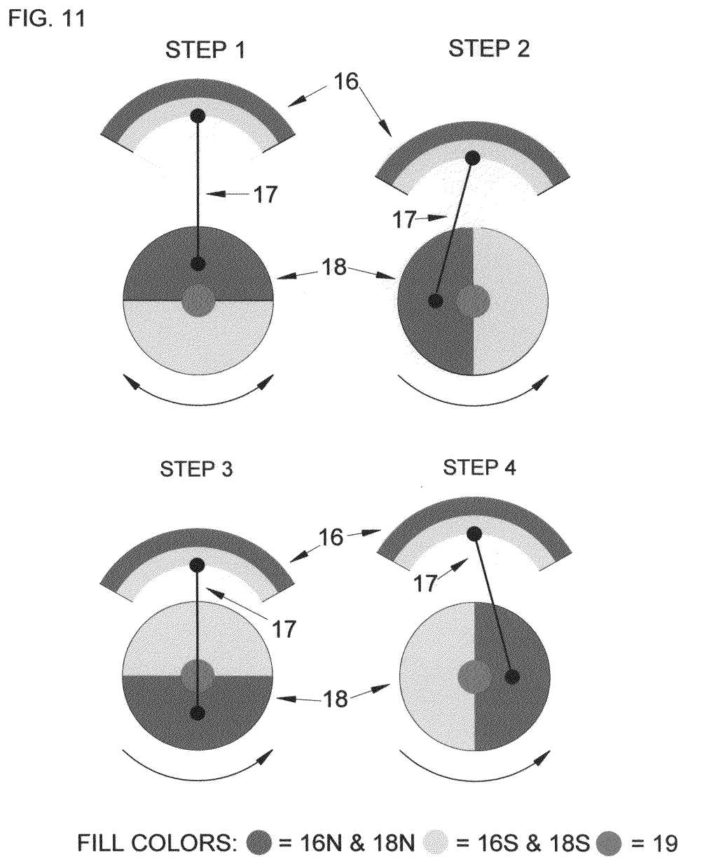

### DETAILED DESCRIPTION OF THE INVENTION

The following paragraphs reference drawing sheet #8 FIG. 8 and illustrates the design and four incremental steps of operation of a basic example of a permanent magnet motor device incorporating the Polar Cross Principle. The following primary components of the apparatus are as follows: magnetic shoe 16 functioning as piston like component with north pole 16N and south pole 16S; rigid push rod assembly 17 with typical wrist pin connection mechanism (details not shown) to shoe 16, and typical crank lobe connection mechanism (details not shown) to cylindrical magnetic core 18; cylindrical magnetic core 18 has north pole 18N and south pole 18S and also has central mounting mechanism 19 for horizontal main shaft (not shown) connection, which is supported by typical mounting bracket (not shown); there is a guide assembly mechanism (not shown) which ensures that piston shoe 16 assembly remains oriented as shown above the magnetic core 18; the linkage and constraint of the apparatus is by means of magnetic fields (between core 18 poles and shoe 16 poles) and also by mechanical means of the connection by the push rod assembly 17.

At step one the core 18 north pole 18N is facing the shoe 16 south pole 16S. There is an attractive force result which makes the core 18 rotate one direction or the other, note the two ended direction of rotation arrow. Arbitrarily, counter clockwise rotation is chosen now and for the rest of the example. The shoe 16 lowers towards the core 18 due to the eccentric connection at the lower end of the push rod 17 to the core 18. Inertia develops as the core 18 turns and the shoe 16 moves closer to the core 18. Step 2 is reached.

At step two the inertia of the core 18 turning and the shoe 16 lowering carries the apparatus through the transition point where the core 18 north pole 18N no longer is entirely facing the shoe 16 south pole 16S. This simple apparatus seems vulnerable still to the issue of resetting here, but more advanced applications of the Polar Cross Principle do not suffer this weakness. Step three is reached.

At step three there is a repulsive force result between the core 18 south pole 18S and the shoe 16S and the core 18 keeps turning counter clockwise. Step 4 is reached.

At step 4 and similar to at step two, the inertia of the core 18 and shoe 16 movement carry the rotation through until step one is reached again.

The following paragraphs describe the design and operation of the preferred embodiment of the invention and refer to drawing sheets #1 through #7.

There is a outer case of the motor assembly 1, with an ordinary mounting bracket 2, and removable top cover (not shown). Within it's perimeter is the outer core 14, or cylinder core 14, which houses the magnetic pistons 4 and some other subsystem components of the motor such as the output torque control components 13, including the control rods 13. Within the outer core's 14 inner perimeter is the inner core 15, or main core 15, mounted on a main shaft 7 assembly, and whose perimeter is comprised of eight bar shaped permanent magnets 5A/B with alternating polarity faces (5A=North versus 5B=South) arranged end to end around the core 15. There may be one or more pistons 4 per bar magnets 5 of the main core 15 in alternate embodiments (not shown).

Lower main shaft 7 is hollow from vane turbine 6 down to integrated open web flange connection inside bearing assembly housing 8 onto output shaft 9 top end integrated open web flange connection to allow hydraulic fluid 3′ flow. The upper main shaft 7B is solid, has bearing assembly (not shown), and extends through top cover with nut. Main bearing assembly 8 includes outer mounting flange, and inner portion of bearing assembly 8′ includes inner mounting flange. The inner 8′ and outer 8 bearing assemblies mount to each other through and around hole (not shown separately) in bottom of outer case 1, and onto the motor mounting bracket 2.

When operating, the sixteen pistons 4 move radially in alternating directions like pistons stroke in their cylinders in typical internal combustion engines, whereas the main core rotates circularly in one direction like the central component of a Wankel/radial internal combustion engine.

Within the main core 15 (comprised of 5A, 5B, 6) is a two level vane turbine 6 assembly. There are hydraulic fluid ports 10A/B (located in partial alignment with the piston faces) beside the offset faces of the bar magnet segments 5A/B surrounding the inner core 15 external perimeter. Approximately one half of the area of the piston 4 faces oppose the bar magnet segments 5A/B, and the other half includes the ports 10A/B.

The main core 15 bar magnets 5A/B are constructed so that as the main core 15 rotates, the face of a magnet segment 5 presented to it's piston 4 aligned is North polarity 5A, then the next segment is of South polarity 5B.

The piston 4 ends are comprised of magnets polarized North and South on their end faces. Every piston 4 is inserted into it's cylinder 11 so that the same polarity face is presented to the main core bar magnet segments 5A/B. Either the North or South face may be used, but all pistons 4 must be aligned with the matching polarity of their inward and outward end faces. The pistons 4 may be accessed through the outer case cylinder access panels F.

The motor case is full of hydraulic fluid when operating. When pistons 4 travel inward due to the magnetic fields of the main core 15 and the pistons 4 themselves, they pump hydraulic fluid 3′ by compression through the top half of the turbine 6 from the cylinder 11 into import areas 10A, and the pistons 4 traveling the other direction simultaneously draw fluid 3′ by pneumatic suction into the cylinder 11 from the lower half of the turbine 6 export areas 10B whose vanes are configured 6R with opposite rotational inclinations to those on the top half 6L of the bi-level turbine assembly 6. An opening 10 exists at the center of the bi-level fan turbine assembly 6 where the fluid 10′ travels downward between levels. Reversal of direction of the inclinations of the vanes (6R versus 6L) reverses the direction of rotation of the main core 15. In practice the turbine 6 part is actually reversible and it's installed orientation dictates the direction of rotation of the motor.

There is another fluid bypass system (not shown) including a channel (not shown) around the exterior of outer core 14 to permit flows between cylinders 11 at their outward ends.

The motor is started by external mounted fluid pumps 3 which pump the hydraulic fluid 3′ through starting ports 12 beside the piston/cylinder assemblies (shown separately) to and through the turbine 6. The external pumping is discontinued upon continued spontaneous operation of the motor due to the utilization of the magnetic fields as the power source to operate it.

The motor can be stopped by a fluid bypass mechanism (not shown) in the cylinder core 14 incorporated into the area of the pistons 4 and cylinders 11 wherein bypass fluid is allowed to flow from cylinder 11 to cylinder 11 as pistons 4 stroke instead of being pumped into turbine import/export ports and forced through 10A and from 10B the turbine 6 vanes.

There is an output shaft 9 of the motor that extends from the bottom of the motor assembly outer case 1 through the lower bearing assembly 8 which is driven by the main shaft 7 which is driven in turn by the turbine 6 assembly.

In summary, the preferred embodiment of the invention detailed above is a permanent magnet motor device utilizing magnetic field energy to operate the motor.

In alternate embodiments of the invention (not shown), some of the permanent magnet components may be replaced by, added to, or augmented by electromagnets or other magnetic components, and other combinations of features of conventional motors and generators may be incorporated into the various device designs enabled by application of the inventive concepts herein.

1. A method—also known as the Polar Cross Method—of the geometrical arrangement and the linkage and/or constraint of two or more magnetized components such that the polarity relationship of the poles of said magnets is reversed concurrently to the relative direction of movement of or between said magnets.

2. A process—also known as the Polar Cross Process—of transforming electromagnetic field energy exhibited by permanent magnets into kinetic energy utilizing the method claimed in claim 1 to achieve the transformation.

3. An apparatus of a permanent magnet motor assembly utilizing the process claimed in claim 2 to produce the motive force to operate the motor.

4. An apparatus of a system of components utilizing the process claimed in claim 2 to produce the motive force to operate the device.
